(19) United States
(12) Patent Application Publication
(10) Pub. No.: US 2008/0253652 A1
(43) Pub. Date: Oct. 16, 2008

(54) METHOD OF DEMOSAICING A DIGITAL MOSAICED IMAGE

(75) Inventors: Pallapothu Shyam, Sundera, Bala, Koteswara Gupta, Bangalore (IN); Krishna Annasagar Govindarao, Bangalore (IN); Kopparapu Suman, Bangalore (IN); Ramakrishna Venkata Meka, Bangalore (IN); Ramkishor Korada, Bangalore (IN)

Correspondence Address: WORKMAN NYDEGGER, 60 EAST SOUTH TEMPLE, 1000 EAGLE GATE TOWER, SALT LAKE CITY, UT, 84111, US

(73) Assignee: ARICENT INC., George Town (KY)

(21) Appl. No.: 12/100,366

(22) Filed: Apr. 9, 2008

(30) Foreign Application Priority Data
Apr. 10, 2007 (IN) 487/DEL/2007

(51) Int. Cl. G06K 9/00

(52) U.S. Cl. 382/167

(57) ABSTRACT

In one example embodiment, a method enables, computing, for a first pixel in the digital mosaiced image, the first pixel being characterized by a first color component and a first set of gradient values in a plurality of orientations, gradient values in the plurality of orientations for a second pixel in the neighborhood of the first pixel. Color values in the plurality of orientations corresponding to a second color component associated with the first pixel based on the set of first gradient values are estimated. The first set of gradient values based at least in part on the computed gradient values is updated. One of the plurality of orientations of the estimated color value based on the updated set of first gradient values is selected and one of the estimated color values corresponding to the selected orientation is determined.

### FIELD OF THE INVENTION

The present invention relates to the field of digital image processing. In particular the present invention provides an enhanced method of demosaicing a digital mosaiced image.

### BACKGROUND OF THE INVENTION

Imaging pipeline refers to the processing that a captured image undergoes before it can be viewed or compressed. Most conventional cameras use single color sensors, i.e., the sensors are sensitive only to the luminance. Color filter arrays (CFAs) are used on top of the sensors to sample one color at each pixel, for example, the Bayer color filter array samples three colors—red, blue and green all over the sensor, sampling green at twice the rate of red and blue. Each pixel therefore has information of only one color. Color filter array interpolation or demosaicing refers to the process of computing all the missing colors at all the pixels. Demosaicing is one of the most complex stages of the imaging pipeline and a good demosaicing algorithm is very important for the overall image quality to be good.

In general there are different kinds of color filter arrays, for example 3 color CFAs typically using RGB or CMY and 4 color CFAs typically using CMYK or RGBE etc. The layouts of the pixels (i.e. the basic repeating unit which covers the whole image) can be different. Bayer CFA refers to RGB CFA with the basic repeating unit consisting of two greens, one red and one blue as shown below.

| | |
|---|---|
| Green | Red |
| Blue | Green |

In general all the demosaicing algorithms perform one, but not limited to, of the steps i.e.: Utilize high frequency information of G image for reconstruction of R and B since, G is sampled at twice the rate of R and B. Ensure constant hue (hue is defined as the ratio of red to green or blue to green), since hue is almost constant in small regions and within objects. (Constant color difference is used instead of constant color ratios or hue in most algorithms)

In CFA interpolation, most effort is directed at interpolating the green channel with minimum error and since green channel is generally used in red/blue interpolation, it follows that the red/blue interpolation will be of a high quality.

Some demosaicing algorithms involve transformations into the spectral domain in order to ensure that the high frequencies of the three color planes are made nearly equal in the demosaiced image. However, such methods may require an initialization.

Some other algorithms work on interpolation maintaining a constant hue, i.e., interpolation of hue rather than the colors, however interpolating color differences (R-G and B-G) has become more popular than interpolating color ratios or hues. Edge directed algorithms that ensure a constant hue (or color differences) in a local neighborhood are most commonly used in modern day cameras. These algorithms generally have three important aspects such as, but not limited to, estimating gradient in different directions, estimating interpolation values in different directions, using gradients to decide the orientation of interpolation.

All the existing techniques either choose the direction/orientation corresponding to the least gradient or give more weightage to the direction of least gradient since interpolation along that direction is bound to be the least erroneous. An example Bayer array is as shown below.

| | | | | |
|---|---|---|---|---|
| R1 | G2 | R3 | G4 | R5 |
| G6 | B7 | G8 | B 9 | G10 |
| R11 | G12 | R13 | G14 | R15 |
| G16 | B17 | G18 | B 1 9 | G20 |
| R21 | G22 | R23 | G24 | R25 |

In one example, the interpolation of green at red is considered, i.e., to estimate green at R13. A simple gradient driven G (Green) interpolation algorithm involves computing the horizontal and vertical gradients using the neighboring pixels (G) and then interpolating in the direction of the lesser gradient. Denoting the gradient in the horizontal direction as ΔH and that in the vertical direction as ΔV,

ΔH=|G12−G14|

ΔV=|G8−G18|

If ΔH is lesser than ΔV, then G13 will be the average of G12 and G14; else it will be the average of G8 and G18. In the unlikely event of the two gradients being equal, G13 is computed as the average of all the four green neighbors.

U.S. Pat. No. 5,382,976 to Hibbard uses gradients as computed above, but instead of merely checking which of the two gradients are lesser, it proposes comparing the horizontal and vertical gradients with programmable thresholds to decide whether interpolation is to occur horizontally, vertically or using all four green pixels.

Another U.S. Pat. No. 5,373,322 to Laroche, et al. computes the horizontal and vertical gradients as illustrated below.

ΔH=|2*R13−R11−R15|

ΔV=|2*R13−R3−R23|

Hibbard used gradients computed from luma in the interpolation of luma, while in this patent gradients computed from chroma were used.

Further, another U.S. Pat. No. 4,774,565 to Freeman to perform the interpolation of all the three colors by interpolating color differences instead of interpolating the colors. This is because the color differences are smoother, and therefore more amenable to interpolation. The color differences are median filtered before being used for reconstruction.

Further more, U.S. Pat. Nos. 5,506,619 to Adams, Jr., et al and 5,629,734 to Hamilton, Jr., et al. have modified the approach given by Laroche's art for defining the gradients by introducing a first order difference term involving the luma, i.e. luma and chroma gradients are both used in making the decision.

ΔH=|2*R13−R11−R15|+|G12−G14|

ΔV=2*R13−R3−R23+G8−G18|

As mentioned hereinabove, the simplest method of estimating the missing color value is to use an edge-sensitive interpolation. Hamilton and Adams have proposed the addition of the chroma correction terms to the interpolated luma, the correction terms being the Laplacian second derivative operators. The updating equation for the green at red can be obtained by using the constant color difference assumption in its 3 pixel neighborhood in the horizontal or vertical direction. Assuming ΔH<ΔV, interpolation for obtaining G13 occurs in the horizontal direction.

G13=(G12+G14)/2+(2*R13−R11−R15)/4

The correction term has been obtained under the assumption of constant color difference in the 5×5 pixels neighborhood. The vertical estimate is similarly obtained. Thus, the task is to decide which one of the two, horizontal estimate or vertical estimate is to be used at the pixel R13.

The U.S. Pat. No. 5,506,619 to Adams, Jr., et al. involves 3 levels of comparisons to decide in favor of the smallest Laplacian, while in the patent, the horizontal and vertical gradients are just compared with each other and interpolation is done in the direction of the lesser one. Thus, the operation involved is,
if ΔH<ΔV
   G13=Ghorz
else
   G13=Gvert
      Variants of the above are commonly used. One possible variant is shown below.
if ΔH<ΔV
   G13=Ghorz
if ΔV<ΔH
   G13=Gvert
if ΔH=ΔV
   G13=(Ghorz+Gvert)/2
      Here Ghorz and Gvert are the horizontal and vertical interpolated values respectively. Another possible variant uses thresholds for the gradients as suggested by Hibbard.

Another patent, U.S. Pat. No. 5,629,734 to Hamilton, Jr., et al. discloses a solution for the demosaicing problem. The correlation between the color planes is exploited for achieving high quality demosaicing. For green interpolation, at every red/blue pixel, horizontal and vertical estimates are computed, the estimates being obtained as the sum of the average of the adjacent green pixels in that direction and a correction term given by the Laplacian of the red/blue pixels in that direction. Gradients are computed in horizontal and vertical directions as the sum of one-second order term (involving pixels of the color of the current pixel) and one first order gradient involving the neighboring pixels in that direction, and the interpolated value in the direction of lesser gradient is used. Red and Blue are similarly interpolated.

Furthermore, in most of the natural images, it is readily apparent that pixels in a small neighborhood have similar gradient information. In practice, it so turns out that neighboring pixels are interpolated in different directions, thus violating the primary consistency as disclosed in Xiaolin Wu and Ning Xang, “Primary-Consistent Soft-Decision Color Demosaicking for Digital Camera, IEEE Transactions on Image Processing, Vol. 13, No. 9, September 2004, pp. 1263-1274. The lighthouse image is the most commonly used to test a demosaicing algorithm, the fence in that image constitutes rapidly varying frequencies and almost all algorithms fail to reconstruct that region without any color artifacts. Keigo Hirakawa and Thomas W. Parks, “Adaptive Homogeneity-Directed Demosaicing Algorithm”, IEEE Transactions on image Processing, Vol. 14 No. 3, March 2005, pp. 360-369 and Xiaolin Wu and Ning Xang, addresses the need for ensuring that all pixels in a small neighborhood are interpolated in the same direction. Both authors obtain two color images and then choose one of the two images' pixels at each pixel of the final image.

Further, the quality of demosaiced images obtained from conventional techniques that are suitable for embedded applications are not as good as that obtained from the iterative or highly complex algorithms, and therefore, there clearly is a need for techniques that provide the quality/performance of the highly complex algorithms but at a much lower complexity thereby making them suitable for embedded applications.

Hence, another difficulty with state-of-the-art algorithms is the complexity, several conventional algorithms are iterative and thus are not suited for, but is not limited to, embedded applications. Several other techniques utilize the whole image for computations and this is very difficult to manage from a memory complexity point of view.

Furthermore, most of the aforementioned arts provide complex algorithms that impart a slightly soft look to the image, i.e., images are slightly blurred with some loss in very high detail regions of the image. While this loss in sharpness can be corrected with an appropriate sharpening stage further along the image pipe, it is better if no loss in sharpness occurs since use of a sharpening filter invites the risk of noise amplification. Also, detail that is lost can never be perfectly regained.

Thus, zipper artifact and false color artifacts are present even in the best of algorithms. Zipper artifacts are the abrupt or unnatural changes in color differences at neighboring pixels, which manifest as an on-off pattern running parallel to a color edge on either side and false artifacts are caused usually by wrong interpolation (or direction of interpolation). As a result, scenes containing very high detail such as, but is not limited to, beads in the lady image, fence in the lighthouse are prone to artifacts when demosaiced.

Yet again, approaches available for demosaicing that are computationally simple also lead to a soft look or a slightly blurred look to the image or require the whole image to be available for processing which is infeasible from a memory point of view.

Thus, there is a need for an algorithm that aids in reducing/removing zipper artifacts while being computationally simple thereby performing well from an objective and subjective point of view.

### SUMMARY OF THE INVENTION

Embodiments of the invention relate to an enhanced method of demosaicing a digital mosaiced image. In one embodiment, the method includes, computing, first pixel in the digital mosaiced image, the first pixel being characterized by a first color component and a first set of gradient values in a plurality of orientations, gradient values in the plurality of orientations for a second pixel in the neighborhood of the first pixel; estimating color values in the plurality of orientations corresponding to a second color component associated with the first pixel based on the set of first gradient values; updating the first set of gradient values based at least in part on the computed gradient values; selecting one of the plurality of orientations of the estimated color value based on the updated set of first gradient values; and determining one of the estimated color values corresponding to the selected orientation.

In yet another embodiment, the method includes, computing gradient values in a plurality of orientations for a first pixel corresponding to a first color component; estimating color values in the plurality of orientations corresponding to a second color component associated with the first pixel based on the computed gradient values; and obtaining a final color value from the estimated color values by computing inverse gradient weighted average using a combination of the estimated color values.

In still another embodiment a method of initializing a transform based method is proposed. The method comprises obtaining demosaiced values from a digital mosaiced image and performing a 1 dimensional frequency based transformation on the obtained demosaiced values.

### BRIEF DESCRIPTION OF THE DRAWINGS

The features, aspects, and advantages of the present invention will be better understood when the following detailed description is read with reference to the accompanying drawings, wherein

FIG. 1 shows an illustrative functional block diagram of a method of processing digital mosaiced image to obtain an interpolated image or demosaiced image with reduced color artifacts in accordance with an exemplary embodiment of the present invention.

FIG. 2 depicts a more detailed functional block diagram compared to the overview of FIG. 1.

FIG. 3(a) is an example Bayer Array considered for illustrating the embodiments of the present invention.

FIG. 3(b) is an example binary map used for illustrating the method of selecting the gradient based on a statistical measure.

FIG. 4 is a flow chart illustrating the example process of computing gradient constancy in accordance with one embodiment of the present invention.

FIG. 5 illustrates an example 7×7 Bayer area considered for illustrating the embodiments of the present invention.

FIG. 6 shows a flow chart that illustrates the example process of computing gradient weighted average in accordance with another embodiment of the present invention.

FIG. 7 shows a flow chart that illustrates the example process of computing color components at an offset from the current pixel in accordance with yet another embodiment of the present invention.

### DETAILED DESCRIPTION OF THE INVENTION

Various Aspects of the invention are described below in different exemplary embodiments of the invention and the drawings, however it will be appreciated for the benefit of the disclosure that the invention is not restricted to particular embodiments described hereinafter and the drawings illustrate merely implementation level details, to aid the reader in understanding the principles of the invention. The underlying principle can be devised and practiced by those skilled in the art in various other ways while not deviating from the spirit and scope of the invention.

It is a principal aspect of the present invention to provide an enhanced method (as disclosed throughout the disclosure hereinafter) based on an example constant color difference principle that can advantageously provide the best definition for the gradient and result in the pixels in the neighborhood to be interpolated or demosaiced in the same direction or orientation. This method can also be used to initialize a transform-based technique. The method of the invention is found to be better compared to the conventional methods based on both subjective and objective quality metric. The objective performance is measured, but not limited to, least mean square value. The method of the invention may be applied to any color-sampling device capable of sampling colors acquired from a sensor in devices such as, but not limited to, cameras, cameras in mobile phones, camcorders, digital still cameras or the like. The color-sampling device can be any of RGB, CMYK, CMY, RGBE or the like.

In one embodiment, a neighborhood is considered in an example Bayer domain (3 rows, 5 rows or 7 rows). With no loss of generality, the Bayer RGB CFA is implied in the present invention. Horizontal and vertical gradients are computed as the absolute value of the sum of three-second order terms. In computing the color difference at the current pixel, a weighted average of the color differences of the neighbors is considered, with the color difference of the immediate neighbors being given a higher weight. Also, the demosaiced values wherever available are used in computing the color difference thereby increasing the accuracy greatly. Gradient constancy is enforced in the neighborhood, which ensures that pixels in a neighborhood have a similar gradient (horizontal or vertical). This ensures homogeneity in interpolation of all color channels, say for example, green channel, thereby facilitating reduction/removal of most unwanted color artifacts.

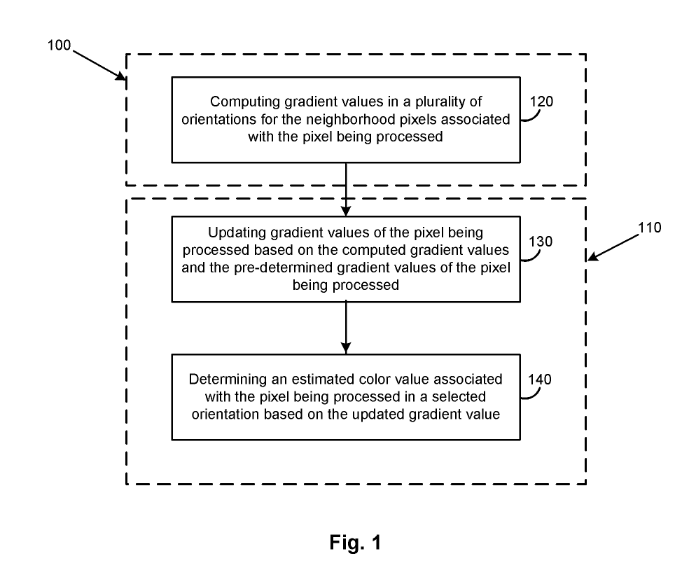

Turning now to FIG. 1, the first basic step 100 comprises the step 120 of computing gradient values in a plurality of orientations for the neighborhood pixels associated with the pixel being processed (referred as throughout the specification as the first pixel or the current pixel) of an example digital mosaiced image. The orientations can be horizontal and vertical or positive and negative diagonals or alternatively a combination thereof. The digital mosaiced image contains pixels forming a mosaic pattern. Each of the pixels contain one color information. The Bayer Array is considered throughout the disclosure as an example, color-sampling device, such as, but not limited to, a CFA. Red, green and blue colors are used in a Bayer Array, also referred as Bayer CFA or RGB CFA, with green being sampled at twice the rate of red and blue. However, it is to be appreciated that the embodiments of the present invention can also be applied in other color sampling-devices such as 3 color CFAs typically using RGB or CMY and 4 color CFAs typically using CMYK or RGBE, or the like.

The next basic step 110 comprises the step 130 of updating gradient values of the pixel being processed based on the computed gradient values and the pre-determined gradient values of the pixel being processed followed by the step 140 of determining an estimated color value associated with the pixel being processed in a selected orientation based on the updated gradient value. In one example, the neighborhood pixel (referred as the second pixel) is at a location that is at an offset of at least two rows and two columns from the location of the current pixel.

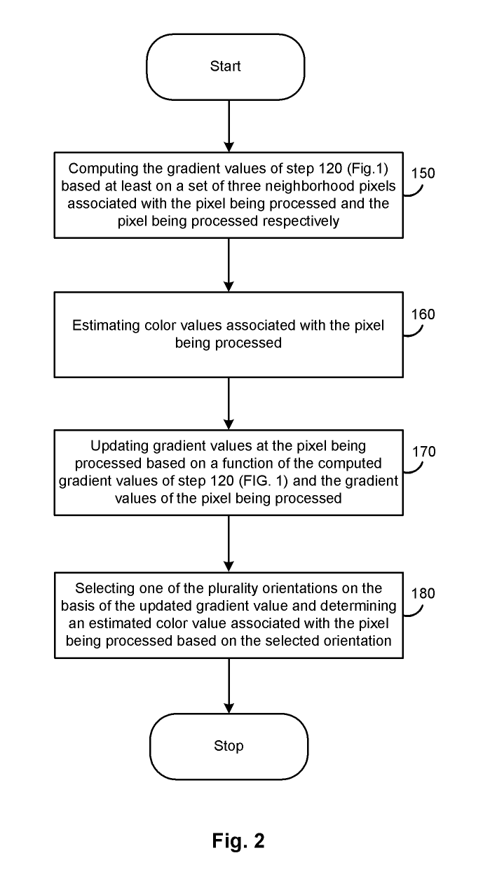

As illustrated in FIG. 2, at step 150 the computing is based at least in part on a set of three neighborhood pixels associated with the first pixel and the first pixel respectively. In one example, the gradient values in a plurality of orientations are computed as a sum of absolute value of at least three-second order terms. In another example, the three-second order terms are Laplacians of the neighborhood pixels associated with the current pixel. Thereafter at step 160, the estimates of a color component (referred as color values) are computed in the plurality of orientations. In one example embodiment, the estimates of the green color component is determined since interpolation of red and blue using the high quality interpolated green plane is relatively straightforward. It is to be appreciated that the terms “interpolating” and “demosaicing” are interchangeably used throughout the disclosure. At step 170, gradient value at the current pixel is updated based on a function of the computed gradient values of step 120 (as shown in FIG. 1) and the gradient values of the current pixel. Generally, gradient value at the current pixel is pre-determined.

The function is derived as a statistical measure of the gradient values of the neighborhood pixels. At step 180, on the basis of the updated gradient value, one of the plurality of orientations is selected and an estimated color value from amongst the estimated color values (as shown in step 160) is determined based on the selected orientation. Thus, gradient constancy is enforced, thereby ensuring that pixels in a neighborhood that are similar are interpolated/demosaiced in a similar manner (for example, but not limiting to horizontal or vertical), which in turn aids in dramatically reducing color artifacts. Zipper artifact is interchangeably referred as color artifact throughout the disclosure.

### Example 1

An example to illustrate gradient constancy is provided hereinbelow:

In an image neighborhood, even if for a single pixel the computed gradient is not same as the actual gradient then it will result in artifacts in the demosaiced image. To prevent this the following gradient constancy enforcement method is employed.

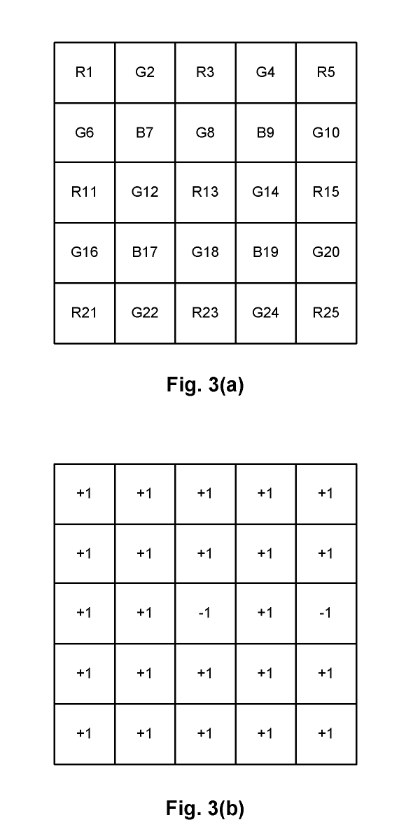

FIG. 3 (a) is an example Bayer Array, where R13 is the pixel that is being processed, then the gradient is calculated for the R25 pixel, which is the current pixel. So ΔH and ΔV for R25 is obtained and the following decision can be done, ΔH is the horizontal gradient of R25 and ΔV is the vertical gradient of R25
If ΔH<ΔV
   Gradient (i,j)=1
Else
   Gradient (i,j)=−1.
(i,j) are the coordinates of the R25 pixel location.
   In this example, since the final value of Green pixel G13 is to be obtained at R13 location, a 5×5 window is taken around R13, which is depicted in FIG. 3(a).

Further, in this example, gradient is a table that stores the information as to in which direction the gradient is predominant, thus 1 is for vertical gradient being predominant and − 1 is for horizontal gradient being predominant. FIG. 3 (b) depicts an example gradient table that illustrates the example binary map values and, thus, in this example, if the current gradient value (i.e. the value computed at R25) is different from the surrounding pixels gradient then the current pixels gradient (i.e. the value computed at R25) is forced to that of the surrounding gradient value. In this example, most of the pixels in the neighborhood indicate the direction of interpolation as horizontal except for a few, which indicates that most probably the gradients estimated at those pixels marked by −1 are misleading. If the current pixel (where the gradients in both directions are computed), in this case R25 is denoted by (i, j), then to enforce gradient constancy at i, j, the gradient constancy is enforced at an offset of at least two rows and two columns from the location of the current pixel, denoted as, (i−2, j−2). The above is further denoted by (k, l) where k=i−2 and l=j−2. The value of FinalGradient (k, l) is given by some statistical measure of the neighborhood gradients. The gradient at a given pixel is computed as some measure of the gradients of its neighborhood, the measure being, but not limited to, mean or median. The neighborhood is defined by an area equivalent to an m×m 2 dimensional array of pixels around the first pixel.

In this example a median of a 5×5 neighborhood is obtained. Thus, at each pixel, when a two dimensional neighborhood N is considered around (i, j), then

FinalGradient (i, j)=F (Gradient (m, n)) where (m, n)εN

i.e., The function Gradient (m, n) is updated with FinalGradient (m, n), i.e.,

Gradient (m, n)=FinalGradient (m, n)

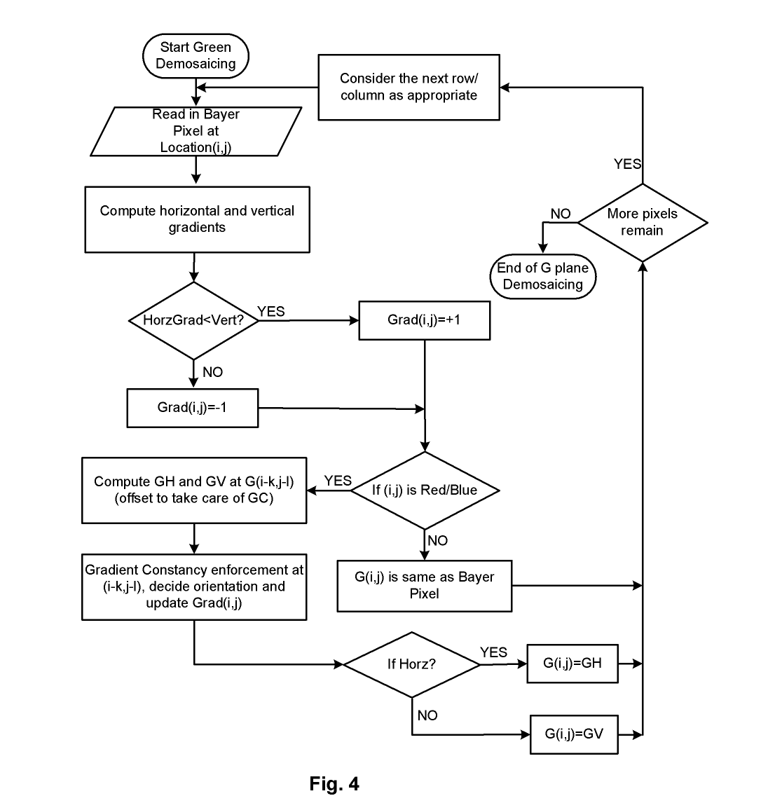

FIG. 4 is an example flow chart illustrating the process disclosed hereinabove. It is to be appreciated that multiple passes through the image can be contemplated. For instance, in the first pass, gradients are computed and Gradient (i, j) is computed for all pixels of the image, in the second pass gradient constancy is enforced (with Gradient being updated) and then the green values are computed in horizontal and vertical directions and the appropriate direction chosen. Reference is made to green plane demosaicing throughout the disclosure since simple color difference based relations are used for obtaining red and blue planes. It is to be understood that if the green plane can be demosaiced satisfactorily, then the red and blue planes also will be demosaiced satisfactorily (since red/blue demosaicing using color difference rule utilizes the green demosaiced values). Thus, all values prior to (k, l) assuming raster scan order will be identical in the two binary valued arrays Gradient and FinalGradient. It is to be noted that all the neighboring pixel gradients are already pre-computed, as the gradients are calculated at an offset, say, two rows and two columns ahead of that of the current pixel, which in this case is R13. This eliminates the difficulty that could be encountered if the gradient at rows (i+1) and (i+2) are required where the gradients are not computed. The area over which gradient constancy is enforced has to be carefully chosen so as to not smear out small details in the image. In this example 5×5 area is used, however, the actual area can be of any other size. In one example the actual area can be chosen depending on the sensor resolution. The area can also be made neighborhood adaptive. Thus, in this example, the final green value, i.e. G13 is obtained by taking the appropriate orientations interpolated values. i.e., in this example:

If FinalGradient (i, j)=1

G13=G13H
Else

G13=G13V

The above example equation indicates that, gradient image (binary valued) is computed, which indicates the preferred direction/orientation of interpolation at each pixel. The directional estimate i.e. in this example G13H or G13V is used as interpolation value or demosaiced value. Thus, if the neighboring pixels have a gradient direction, which is not the same as the current pixel, then the current pixels gradient is forced to that of the neighboring pixels gradient direction. Gradient constancy as disclosed herein refers to making the current pixels gradients the same as the neighboring pixels gradients.

In accordance with one embodiment of the present invention the method for constant color difference at the current pixel considers a weighted average of the color differences of the neighbors with the color difference of the immediate neighbors being given a higher weight. Also, the demosaiced values wherever available are used in computing the color difference thereby increasing accuracy. Further, this gives a better estimate rather than merely averaging (weights assumed equal), this is important since the color differences are constant only in an average sense. Also using previously demosaiced or interpolated values wherever possible improves the color differences immensely.

### Example 2

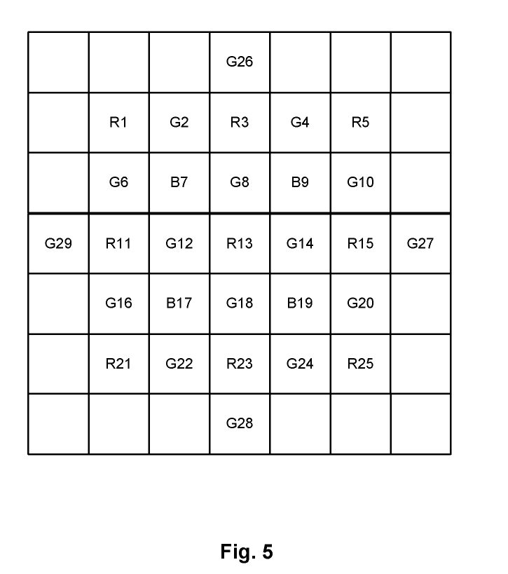

An example equation illustrating the method in accordance with an embodiment is disclosed hereinbelow. FIG. 5 illustrates an example 7×7 Bayer area. In this example, to determine green G13 at red pixel R13, the color difference R-G at the center pixel in the horizontal direction is determined as,

R13−G13=α*(R11−G11)+β*(R12−G12)+γ*(R14−G14)+δ*(R15−G15)

i.e., the color difference at the center pixel is determined as the weighted average of the color difference of the neighboring pixels in the example horizontal orientation. The weights in this example add up to unity (α+β+γ+δ=1).
In the present implementation weights are chosen to be one of the following two sets (with no loss of generality)
α=¼, =¼, γ=¼, δ=¼
α=⅛, β=⅜, γ=⅜, δ=⅛. It is to be appreciated that the weights in computing constant color difference formula can vary from the ones disclosed herein and can be adaptive.

In the above expression, all the colors are not known. R11, G12, R13, G14 and R15 are known. Since the pixel R13 is being demosaiced, it is appreciated that G11 is known since it will have already been demosaiced.

R12 is taken either as (R11+R13)/2 or as (R11−G11)+G12.
R14 is computed as (R13+R15)/2, and G15 is taken as (G14+G27)/2.
Since R13 is known and the right-hand-side of the above equation is known, G13 in the horizontal direction can be computed and is denoted by G13H. Similarly G13V is computed using the pixels in the vertical direction. Thus the example horizontal and vertical gradients are computed according to the following expression.

ΔH=|2*R13−R11−R15|+|2*G12−G29−G14+|2*G14−G12−G27|

ΔV=|2*R13−R3−R23|+|2*G8−G26−G18|+|2*G18−G8−G28|

In case ΔH<ΔV then gradient (i, j)=1 is employed otherwise gradient (i, j)=−1 is employed. The estimates of the example green value are computed in the horizontal and vertical direction.

G13H=(2*G11+6*G12+7*G14+G27)/16+(2*R13−R11−R15)*(5/16)

Where all except G11 are Bayer values (or sampled values) while G11 is a demosaiced value.

G13V=(2*G3+6*G8+7*G18+G28)/16+(2*R13−R3−R23)*(5/16)

where all except G3 are Bayer values (or sampled values) while G3 is a demosaiced value. In one embodiment, the directional estimate used for determining the interpolation value is computed as disclosed in example 1. It is to be appreciated that the neighborhood used can be different from 7×7. This implies that the color difference can be computed as the weighted average of more than four terms as shown in each direction.

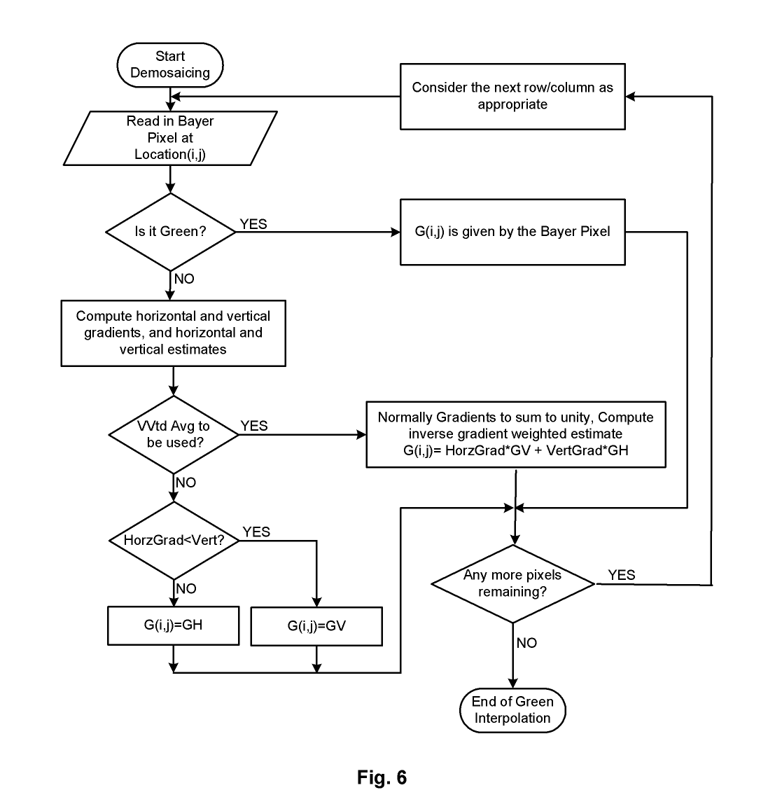

In another alternative embodiment, the estimates obtained in a plurality of orientations are combined using weights computed from the gradients. FIG. 6 shows a flow chart that illustrates another embodiment of the method in accordance to the present invention. In this embodiment, inverse gradient weighted average is computed using a combination of the computed estimated values of an example color component in a plurality of orientations. In one example the computed estimated values are combined using the computed gradient values computed as weights. The computation of the gradient values as weights can include normalization of the computed gradient values to sum to unity.

### Example 3

An example illustrating the method in accordance with the above embodiment of the invention is disclosed hereinbelow: In this example method a weighted average of the horizontal and the vertical interpolated or demosaiced values are taken with weights governed by the value of the gradient

The sum of the gradient values are computed. The gradient values can be obtained as indicated in example 2 disclosed hereinabove for computing G13.

S13=ΔH+ΔV.

Horizontal and vertical gradients are divided with the sum to get the normalised example horizontal and vertical gradients.

NΔH=ΔH/S13

NΔV=ΔV/S13

This process makes NΔH+NΔV=1, so that they can be used as weights. The final green value, in this example is thus obtained using a combination of the horizontal and vertical estimates with the normalized values obtained used as weights as given hereinbelow:

G13=NΔH*G13V+NΔV*G13H.

For instance: if ΔH=1.7 and ΔV=3, then S13=4.7 and finally NΔH=0.361 and NΔV=0.639. Also NΔH+NΔV=1.
The inverse gradient weighted combination is obtained as:

G13=NΔH*G13V+NΔV*G13H

It is to be appreciated that the inverse gradient weighted combination can be obtained as per any other gradient definition. This method is herein referred as the gradient average method. In effect the gradient weighted average method ensures that the direction or orientation in which gradient value is more gets less weight and the direction or orientation in which the gradient value is less gets more weight in the final calculation.

The aforementioned approach uses a neighborhood of 7×7 to enforce constancy of color difference. The same can be achieved using 5 rows and even 3 rows in case there is a need to limit the buffering of image content. Further, referring to example 2, the pixels can be determined by R13−G13=α*(R11−G11)+β*(R12−G12)+γ*(R14−G14)+δ*(R15−G15) wherein, G11 is a demosaiced green value, R12 is computed either as the average of R11 and R13 or using the color difference formula as R11−G11+G12. G15 is unknown, and either can be approximated by G14 or that term can be dropped altogether. The approach therefore will consist of only 3 terms. R13−G13=α*(R11−G11)+β*(R12−G12)+γ*(R14−G14). With weights α+β+γ=1. The final expression can be obtained by simplifying the above expression with appropriate weights.

Further, non-green colors, such as red and blue colors can be computed using simple color difference interpolation. In one example, referring to FIG. 4, the Bayer area shown therein can be employed to determine the red/blue interpolation. For instance, in this example, to obtain red and blue at G12 (a green pixel in a red row),

R12=((R11−G11)+(R13−G13))/2+G12

B12=((B7−G7)+(B17−G17))/2+G12

To obtain red and blue at G8 (a green pixel in a blue row),

R8=((R3−G3)+(R13−G13))/2+G8

B8=((B7−G7)+(B9−G9))/2+G8

To obtain red at B7 (red at blue)

R7=((R1−G1)+(R3−G3)+(R11−G11)+(R13−G13))/4+G7

To obtain blue at R13 (blue at red)

B13=((B7−G7)+(B9−G9)+(B19−G19)+(B17−G17))/4+G13

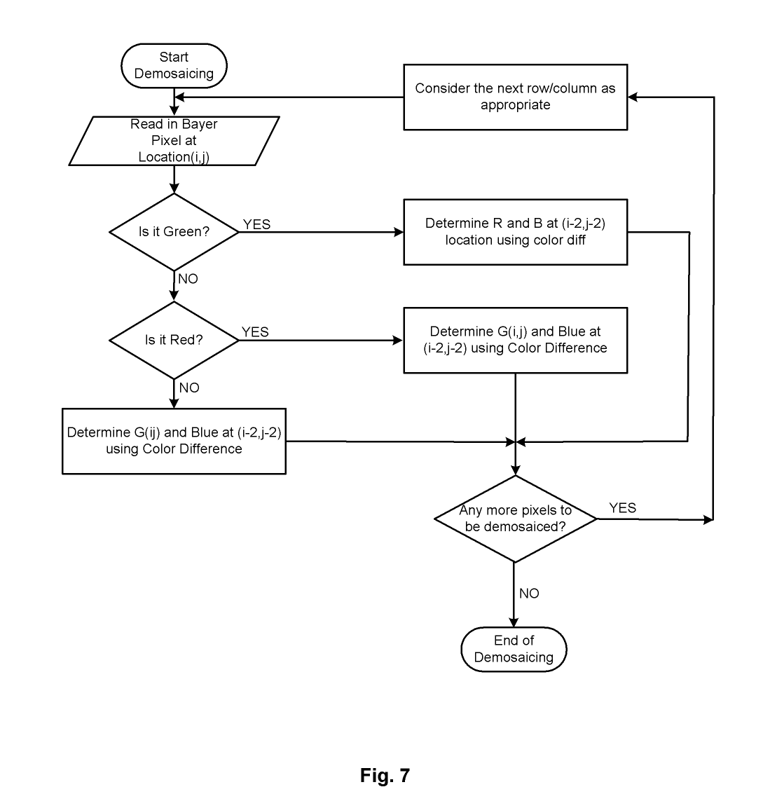

Since, demosaiced green plane intensities are used, the problem of causality arises, i.e., blue at red (B13 at R13) cannot be computed unless the green values at blue pixels in the next row (G17 and G19) are known. To overcome this problem, red and blue values are computed at an example location (i−2, j−2) if the current pixel location is (i, j) i.e. the red and blue values at green pixels are computed with a lag of two rows to overcome the causality constraints. Referring to the Bayer area of FIG. 4 and to FIG. 7, suppose the current pixel (i,j) is G24. The particular row, where R and B are to be estimated (at G12), is a RGRG row, and therefore red and blue are determined by using color differences in horizontal and vertical directions respectively.

R12=(R11−G11+R13−G13)/2+G12

B12=(B7−G7+B17−G17)/2+G12

If the particular row where R and B are to be estimated is a BGBG row, for example at G8, the expressions are

R8=(R3−G3+R13−G13)/2+G8

B8=(B7−G7+B9−G9)/2+G8

Red at blue pixel and blue at red pixel are estimated as follows. Blue B13 at red pixel R13 is given by,

B13=(B7−G7+B9−G9)/2+G13

Red R7 at blue pixel B7 is estimated as follows,

R7=(R1−G1+R3−G3)/2+G7

The red at blue and blue at red pixels can also be estimated considering the average color difference of all four diagonal pixels. Another variation can be to use diagonal gradients and use the average color difference in the direction of the lesser gradient to compute red at blue or blue at red.

The various embodiments of the method as disclosed herein can be used to initialize the transform based green updating algorithm (followed by red and blue demosaicing using color difference) to, inter alia further improve the subjective and objective quality. The method of the present invention can also be referred as an initialization algorithm when used in the context of an example transform-based green updating algorithm.

However, it is to be appreciated that the initializing algorithm can be used alone (without the example transform based green updating algorithm) since it also performs satisfactorily when implemented separately. Alternatively/additionally the initialization algorithm can be used for conventional iterative techniques or transform domain methods.

It is contemplated that the transform-based method referred hereinbefore when implemented in one dimension also aids in dramatically removing/reducing zipper artifact, which is a problem in most transform/spectral methods. The freedom of being able to choose the appropriate direction of interpolation in a transform-based method enables to remove/reduce zipper artifact while still retaining the high accuracy of transform based methods. This method is importantly aimed at green interpolation with simple color difference based interpolation being used for red/blue planes.

Thus, considering the interpolation in one-dimensional space enables to incorporate directionality in the transform based method (if 2-D transforms are used there is no question of directional interpolation). Thus zipper artifacts can be removed/reduced drastically compared to 2-D methods while still retaining accuracy in plain areas of the image. Further, it is to be appreciated that the transform-based method can be a 1 dimensional frequency based transformation that is applied on the interpolated value obtained in accordance with various embodiments of the present invention. The 1-dimensional frequency based transformation can be a 1-dimensional Discrete Cosine Transform (DCT), Discrete Wavelet Transform (DWT), and Discrete Hartley Transform (DHT) or the like.

In one example, 1-dimensional Discrete Cosine Transform (1-D DCT) is considered. In this example, the 1-dimensional Discrete Cosine Transform (DCT) is considered only as a refinement algorithm and the initial value for this technique is the output of the method in accordance with various embodiments of the present invention or any other demosaicing method.

An enhancement technique is proposed hereinbelow which comprises of using a 1-D DCT to refine the demosaiced value. In an example, implementation, disclosed herein is a brief description of an example 1-DCT algorithm when used in conjunction with the example embodiments of the method of the present invention. The DCT technique when used results in the high frequency content of a pixel say R3 to be passed on to G3, where R3 and G3 are interpolated values obtained in accordance with the method of the present invention. This ensures the accuracy of the high frequency content. For pixel R3, two set of data are arranged, r={R1, r2, R3, r4, R5} and g={g1, G2, g3, G4, g5} these data are from the initial demosaicing process, The initial interpolated estimates of the red and green values are denoted by lower case letters, i.e., g1, r2, g3, r4, g5. Now 1D DCT can be taken for r and g separately to obtain dr={dr1, dr2, dr3, dr4, dr5} and dg={dg1, dg2, dg3, dg4, dg5} respectively. It is contemplated that since at R3 red color is directly captured from the sensor, the high frequency of this color will be more accurate for this pixel. In a 1D DCT the high frequencies are represented by the 3^{rd}, 4^{th} and 5^{th} coefficients, the 3^{rd} 4^{th} and 5^{th} coefficients of dg is replaced by that of dr to obtain dg′={dg1 dg2 dr3 dr4 dr5}. This dg′ is then Inverse transformed i.e, an Inverse Discrete Cosine Transform (IDCT) of dg′ is obtained to obtain g′={g1, g2, g3, g4, g5}, Now g3 is the horizontal estimate for the green at R3 in figure. The same process is repeated in the vertical direction by taking 1-D DCT and following the above steps. Using the gradient value for horizontal and vertical direction the appropriate green color is selected. It is to be appreciated, that introduction of good high frequency components into the image improves the output quality, thereby enabling to preserve or enhance the high frequency content of the image.

It will be appreciated that the teachings of the present invention can be implemented as a combination of hardware and software. The software is preferably implemented as an application program comprising a set of program instructions tangibly embodied in a computer readable medium. The application program capable of being read and executed by hardware such as a computer or processor of suitable architecture. Similarly, it will be appreciated by those skilled in the art that any examples, flowcharts, functional block diagrams and the like represent various exemplary functions, which may be substantially embodied in a computer readable medium executable by a computer or processor, whether or not such computer or processor is explicitly shown. The processor can be a Digital Signal Processor (DSP) or any other processor used conventionally capable of executing the application program or data stored on the computer-readable medium.

The example computer-readable medium can be, but is not limited to, (Random Access Memory) RAM, (Read Only Memory) ROM, (Compact Disk) CD or any magnetic or optical storage disk capable of carrying application program executable by a machine of suitable architecture. It is to be appreciated that computer readable media also includes any form of wired or wireless transmission. Further, in another implementation, the method in accordance with the present invention can be incorporated on a hardware medium using ASIC or FPGA technologies.

It is to be appreciated that the subject matter of the claims are not limited to the various examples an language used to recite the principle of the invention, and variants can be contemplated for implementing the claims without deviating from the scope. Rather, the embodiments of the invention encompass both structural and functional equivalents thereof.

While certain present preferred embodiments of the invention and certain present preferred methods of practicing the same have been illustrated and described herein, it is to be distinctly understood that the invention is not limited thereto but may be otherwise variously embodied and practiced within the scope of the following claims.

We claim:

1. A method of demosaicing a digital mosaiced image, the method comprising:
computing, for a first pixel in the digital mosaiced image, the first pixel being characterized by a first color component and a first set of gradient values in a plurality of orientations, gradient values in the plurality of orientations for a second pixel in the neighborhood of the first pixel;
estimating color values in the plurality of orientations corresponding to a second color component associated with the first pixel based on the set of first gradient values;
updating the first set of gradient values based at least in part on the computed gradient values;
selecting one of the plurality of orientations of the estimated color value based on the updated set of first gradient values; and
determining one of the estimated color values corresponding to the selected orientation to obtain a demosaiced value.

2. The method according to claim 1, wherein the computing is based at least in part on a set of three neighborhood pixels associated with the first pixel and the first pixel respectively.

3. The method according to claim 1, wherein the step of computing computes color difference at the first pixel as a weighted average of color differences of the neighborhood pixels associated with the first pixel.

4. The method according to claim 3, wherein the color differences of the neighborhood pixels at nearby locations is assigned a higher weight.

5. The method according to claim 1, wherein the estimating includes using predetermined estimated color values.

6. The method according to claim 1, wherein the second pixel is at a location that is at an offset of at least two rows and two columns from the location of the first pixel in an m×m neighborhood.

7. The method according to claim 1, wherein the updating comprises computing a function of the computed gradient values and the first set of gradient values.

8. The method according to claim 7, wherein the updating further comprises computing a median of the computed gradient values in the neighborhood of the first pixel and the first set of gradient values.

9. The method according to claim 8, wherein the neighborhood of the first pixel is defined by an area equivalent to an m×m 2 dimensional array of pixels around the first pixel.

10. The method according to claim 1, wherein the updating further comprises computing a mean of the computed gradient values in the neighborhood of the first pixel and the first set of gradient values.

11. The method according to claim 10, wherein the neighborhood of the first pixel is defined by an area equivalent to an m×m 2 dimensional array of pixels around the first pixel.

12. The method according to claim 1, wherein the first color component corresponds to the color red.

13. The method according to claim 1, wherein the second color component corresponds to the color green.

14. The method according to claim 1, wherein the first color component corresponds to the color blue.

15. The method according to claim 1, wherein the first and the second color components correspond to color components of any of RGB, CMY or the like.

16. The method according to claim 1, wherein the first and the second color components correspond to color components of any of CMYK, RGBE or the like.

17. A method of demosaicing a digital mosaiced image, the method comprising:
computing gradient values in a plurality of orientations for a first pixel corresponding to a first color component;
estimating color values in the plurality of orientations corresponding to a second color component associated with the first pixel based on the computed gradient values; and
obtaining a final color value from the estimated color values by computing inverse gradient weighted average using a combination of the estimated color values.

18. The method according to claim 17, wherein the combination includes computing the computed gradient values as weights.

19. The method according to claim 18, wherein the computation of the gradient values as weights includes normalization of the computed gradient values to sum to unity.

20. The method according to claim 17, wherein the computing is based at least in part on a set of three neighborhood pixels associated with the first pixel and the first pixel respectively.

21. The method according to claim 17, wherein the step of computing computes color difference at the first pixel as a weighted average of color differences of the neighborhood pixels associated with the first pixel.

22. The method according to claim 17, wherein the color differences of the neighborhood pixels at nearby locations is assigned a higher weight.

23. The method according to claim 17, wherein the estimation includes using predetermined estimated color values.

24. The method according to claim 17, wherein the first color component corresponds to the color red.

25. The method according to claim 17, wherein the first color component corresponds to the color blue.

26. The method according to claim 17, wherein the second color component corresponds to the color green.

27. The method according to claim 1, further comprising performing a 1 dimensional frequency based transformation on the demosaiced value.

28. The method according to claim 17, further comprising performing a 1 dimensional frequency based transformation on the demosaiced value.

29. The method according to claim 27, wherein the 1 dimensional frequency based transformation includes a 1-dimensional discrete cosine transform.

30. A computer programmed to perform the method of claim 1.

31. A computer programmed to perform the method of claim 17.

32. A computer-readable medium, tangibly embodying a set of program instructions that, when executed, cause a computer to perform the method according to claim 1.

33. A computer-readable medium, tangibly embodying a set of program instructions that, when executed, cause a computer to perform the method according to claim 17.

34. A method of demosaicing a digital mosaiced image, the method comprising:
obtaining demosaiced values from the digital mosaiced image; and
performing a 1 dimensional frequency based transformation on the obtained demosaiced values.

35. The method according to claim 34, wherein the 1 dimensional frequency based transformation includes a 1-dimensional discrete cosine transform.
